(19) United States
(12) Patent Application Publication
(10) Pub. No.: US 2015/0242870 A1
(43) Pub. Date: Aug. 27, 2015

(54) PRODUCT TRADE-IN DURING PURCHASE FLOW WITHIN MULTI-SELLER ENVIRONMENT

(71) Applicant: Glyde Corporation, Palo Alto, CA (US)

(72) Inventors: Simon Rothman, Palo Alto, CA (US); Christopher Kang, Palo Alto, CA (US); David Shuffelton, Palo Alto, CA (US)

(73) Assignee: Glyde Corporation, Palo Alto, CA (US)

(21) Appl. No.: 14/190,002

(22) Filed: Feb. 25, 2014

(51) Int. Cl. G06Q 30/02

(52) U.S. Cl. CPC G06Q 30/0208

(57) ABSTRACT

Embodiments of the invention introduce systems and methods for providing a trade-in capability in connection with a product purchase by communication with a marketplace of third party used product buyers.

### CROSS-REFERENCES TO RELATED APPLICATIONS

NOT APPLICABLE

### BACKGROUND OF THE INVENTION

The present invention relates to ecommerce including the trade-in of used products.

Existing systems provide for ecommerce with the trade-in of a product of the same seller when purchasing a new product from that seller. One example, which also includes a description of other prior art, is in Oshima et al. U.S. Pat. No. 7,725,380.

There are also existing ecommerce used product marketplaces, such as eBay and Amazon.com. In addition, there are many ecommerce marketplaces for new products. However, there is a lack of an effective combination of such marketplaces in a manner that provides a customer friendly experience.

### BRIEF SUMMARY OF THE INVENTION

Embodiments of the invention introduce systems and methods for providing a trade-in capability in connection with a product purchase by communication with a marketplace of third party used product buyers.

In one embodiment, the present invention provides a server computer with a processor and non-transitory computer readable medium with code, executable by said processor, to implement a trade-in method in connection with purchasing a product. A buy window is provided for a customer to purchase a product for sale. When the buy window is activated, an option for trade-in of a used product is provided, either in the buy window, a pop-up, or otherwise. If the customer responds, the customer is prompted to provide a product description of the used product. This could be by entering a description, searching for used products, clicking on suggested used products, etc.

The used product description is provided to a used product marketplace module. Potential buyers of the used product in the used product marketplace are identified. The used product sell price offered by a potential third party buyer is determined. A used product sell price is then displayed to the customer, and is typically related to, but not the same as, the used product sell price.

### BRIEF DESCRIPTION OF THE DRAWINGS

FIG. 1 shows an ecommerce trade-in system according to an embodiment of the invention.

FIG. 2 shows a flow diagram illustrating a trade-in process according to some embodiments of the invention.

FIGS. 3-7 show embodiments of user interfaces for different stages of the trade-in process of FIG. 2.

FIG. 8 is a high level block diagram of a computer system that may be used to implement any of the entities or components described for embodiments of the invention.

### DETAILED DESCRIPTION OF THE INVENTION

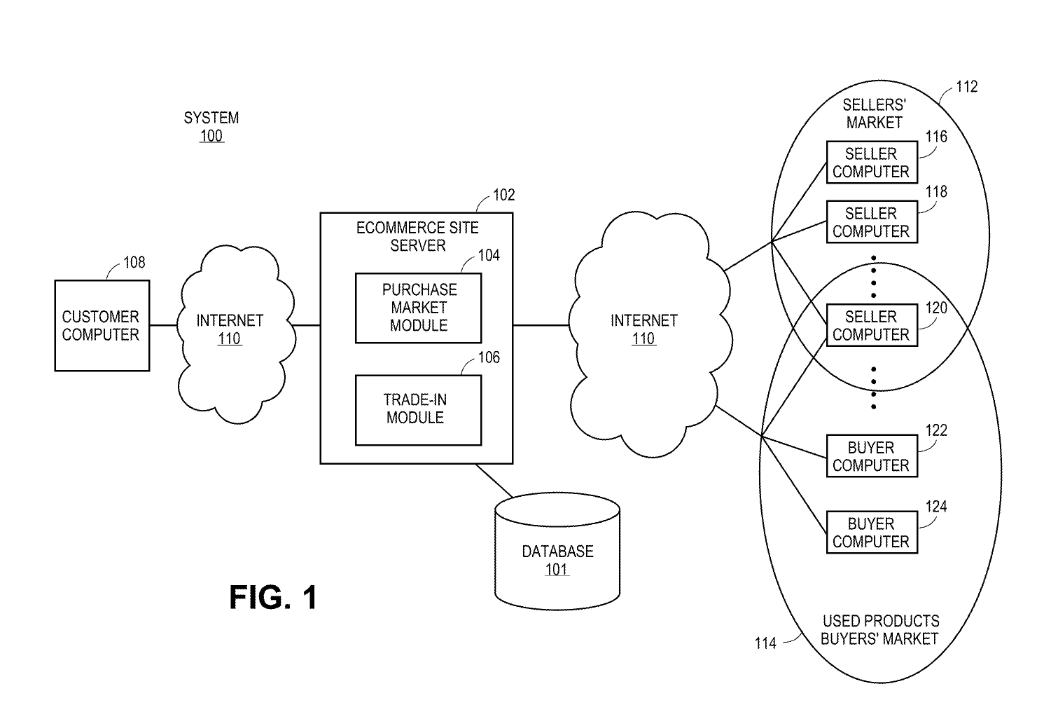

FIG. 1 is a diagram of an embodiment of a system 100 according to the present invention. A server 102 and database 101 implement an ecommerce site and includes a purchase market module 104 and a trade-in market module 106. A customer computer 108 is connected to server 102 through the Internet 110. Server 102 is connected to Internet 110 to a sellers' market 112 and also to a used product buyers' market 114. Sellers' market 112 includes individual computers 116, 118 and 120. Used product buyers' market 114 include computers 124, 122 and computer 120. Note that computer 120 is in both markets. The actual marketplaces include many thousands or millions or more computers of various buyers and sellers. The computers can take any form, including servers, laptops, smart phones, tablets, etc. The modules can be on the same or different servers, and can have overlapping functionality and resources. The server 102 includes the associated database(s), which can also have separate and/or overlapping resources.

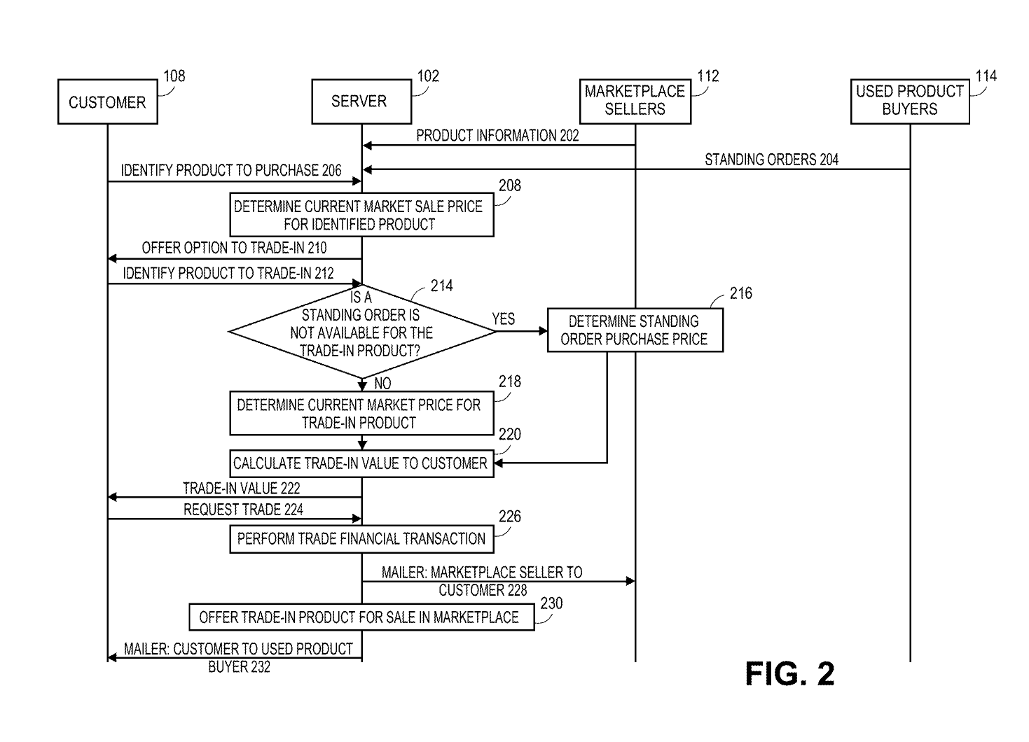

FIG. 2 is a flow diagram illustrating a trade-in process according to some embodiments of FIG. 1. The diagram shows the interaction between the customer computer 108, the server 102, the sellers' marketplace 112 and the used product buyers' market 114. In step 202, product information is obtained from the marketplace sellers and stored on server 102. In a step 204, standing orders for used products that buyers that are willing to buy identified products is provided from the used product buyers' market 114 to server 102.

Customer 108 will access an ecommerce website provided by server 102 and identify a product the customer wants to purchase. In step 206, server 102 determines the current market sale price for that product. In step 208, one embodiment of a method for determining the sale price is set forth in U.S. Pat. No. 8,447,645, the disclosure of which is hereby incorporated herein by reference. The product price and availability is then displayed the customer. In step 210, the customer is also offered an option to trade-in a used product. In step 212, the customer identifies any product desired to be traded-in. In step 214, server 102 determines if there is a standing order available for that trade-in product. If there is, the standing order purchase price is determined in step 216. If there is no standing order, the current market price for the trade-in product is determined in step 218. This determination can be done by examining historical prices offered by used product buyers, or by posting an inquiry or opportunity to the used product buyer marketplace.

In step 220, a trade-in value for the customer is calculated. This value will typically be related to, but not identical with the best price from the used product buyers. The difference accounts for the need for a profit margin, shipping costs, etc. The trade-in value is then displayed to the customer in step 222. The customer may then respond with an affirmative request for trade-in in step 224. In step 226, the financial transaction is completed by obtaining payment from the customer for the identified product and providing a tentative credit to the buyer for the trade-in product.

In step 228, a mailer is sent from the organization running server 102 and the ecommerce site to the identified marketplace seller. This mailer includes postage appropriate for sending the purchased product from the seller to the customer, including shipping costs based on the respective addresses of the seller and customer. One embodiment of a method for handling such a mailer is set forth in U.S. Pat. No. 7,899,716, the disclosure of which is hereby incorporated herein by reference.

In step 230, the trade-in product is offered for sale in the used product marketplace. This is typically done only if there's not an existing standing order, or a particular buyer has not already been previously identified. For example, server 102 may know the historical average purchase price from used product buyers and use that to calculate an appropriate trade-in value for the customer, without having a committed buyer at the time. Upon identification of a used product buyer, a mailer is sent to the customer in step 232 with the used product buyer's address and postage calculated according to the respective addresses of the customer and buyer.

In one embodiment, payment is handled by a credit, debit or other payment card or other payment service, such as PayPal or an online currency. The customer is provided a tentative credit, but that credit is not awarded until receipt by the used product buyer of the trade-in product, and confirmation by the buyer that the product is in satisfactory condition. The credit may take a variety of forms, such as a charge back credit to a credit card account, or a credit for online currency usable at the ecommerce marketplace operated by server 102.

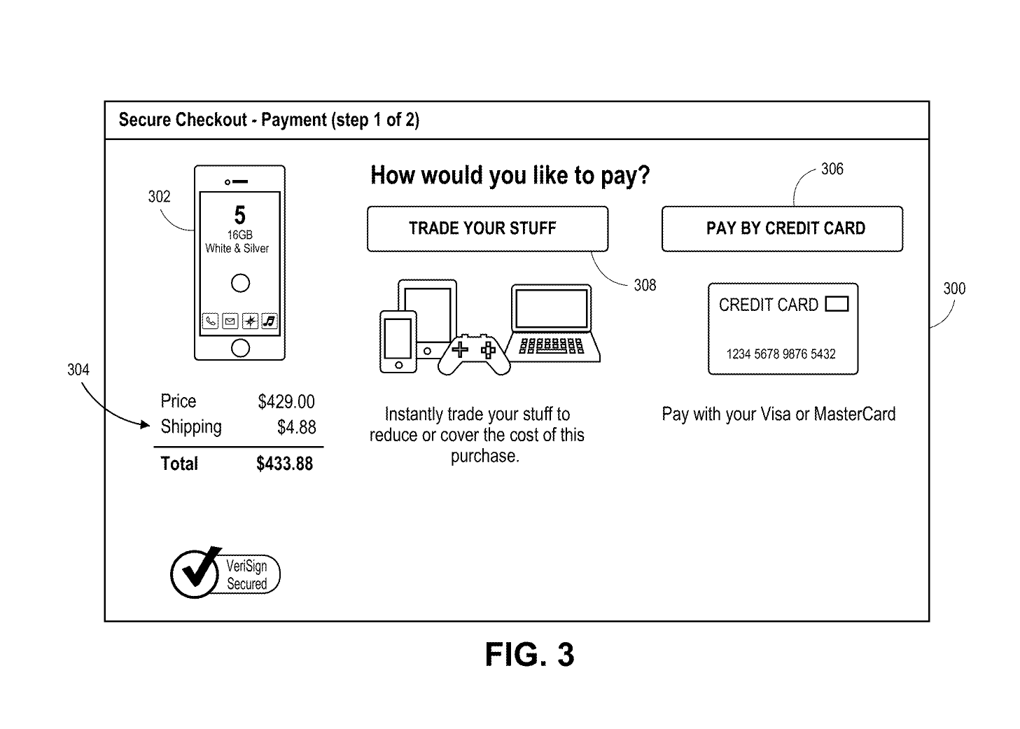

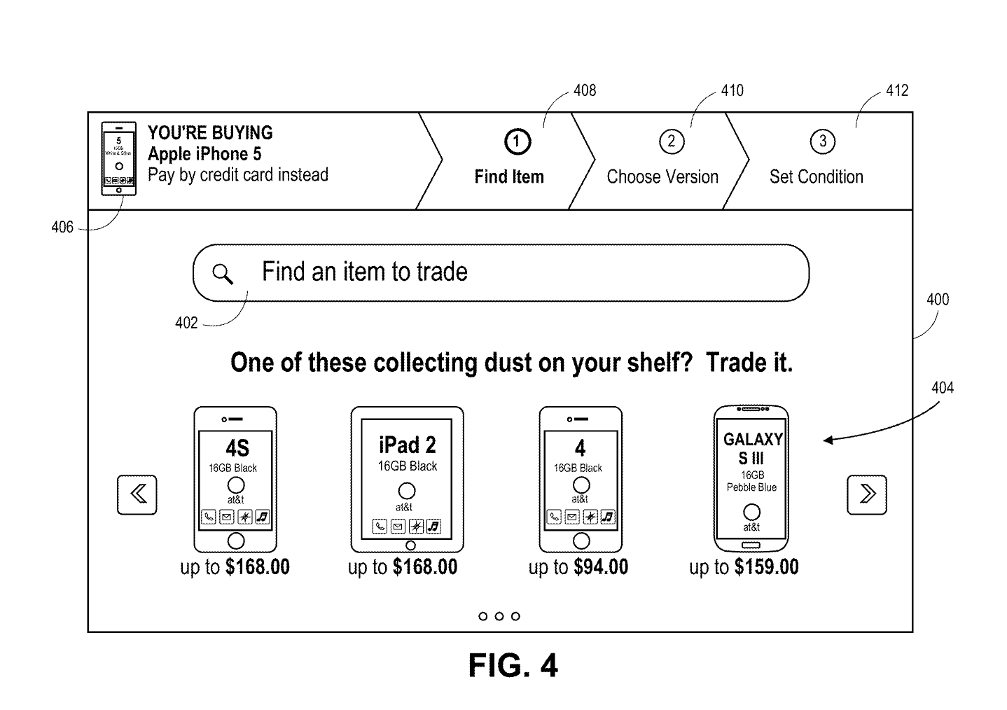

FIG. 3 illustrates one embodiment of a user interface window 300 according to the present invention. In this embodiment, the customer has already selected a phone 302 for purchase. An image of the phone is displayed along with pricing information 304. The customer is provided an option to pay by credit card as indicated by icon 306. Alternately, the customer is presented an option for trade-in indicated by icon 308. If the customer selects icon 308, a window such as that in FIG. 4 is displayed.

FIG. 4 illustrates one embodiment of a trade-in window 400. In this embodiment, the customer is given two options for describing a trade-in product. First, the customer can type in the product description in search field 402. Second, window 400 displays a number of items 404 that are related to the item the customer has selected to purchase. Items 404 are pulled from a database storing products identified from the used product buyers' market as having interested buyers. The search terms entered in search field 402 will be applied to the same database to search for items matching that description for which interested buyers can be located.

FIG. 4 also illustrates at the top of the window a description 406 of the product the customer has selected to buy. The window also indicates the steps needed to complete the trade-in process. The first step, shown in window 400, is finding the item (step 408). The next step is choosing a version (step 410), and then describing the condition of the used product in step 412.

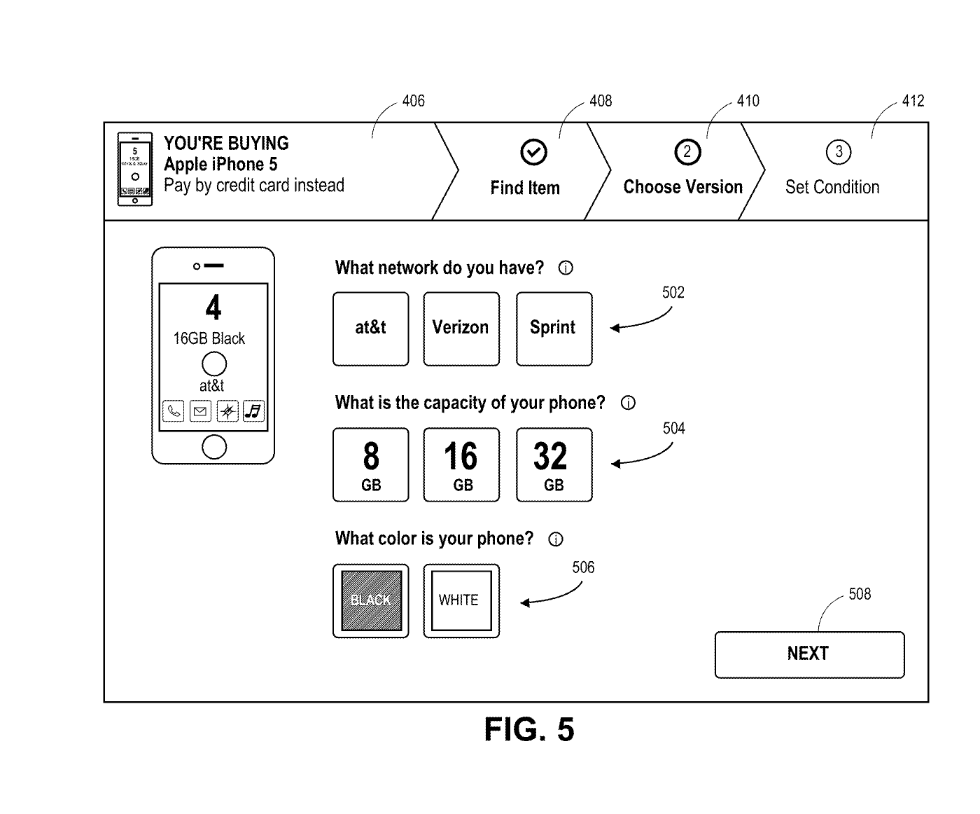

FIG. 5 illustrates one embodiment of the “choose version” step 410. Multiple characteristics of the product are displayed with various options. The customer selects the options to describe the trade-in product the customer has. For the example of a used smart phone, the customer selects the phone network 502, the memory capacity 504 and the color 506. The customer then hits the next button 508 to move to the next screen.

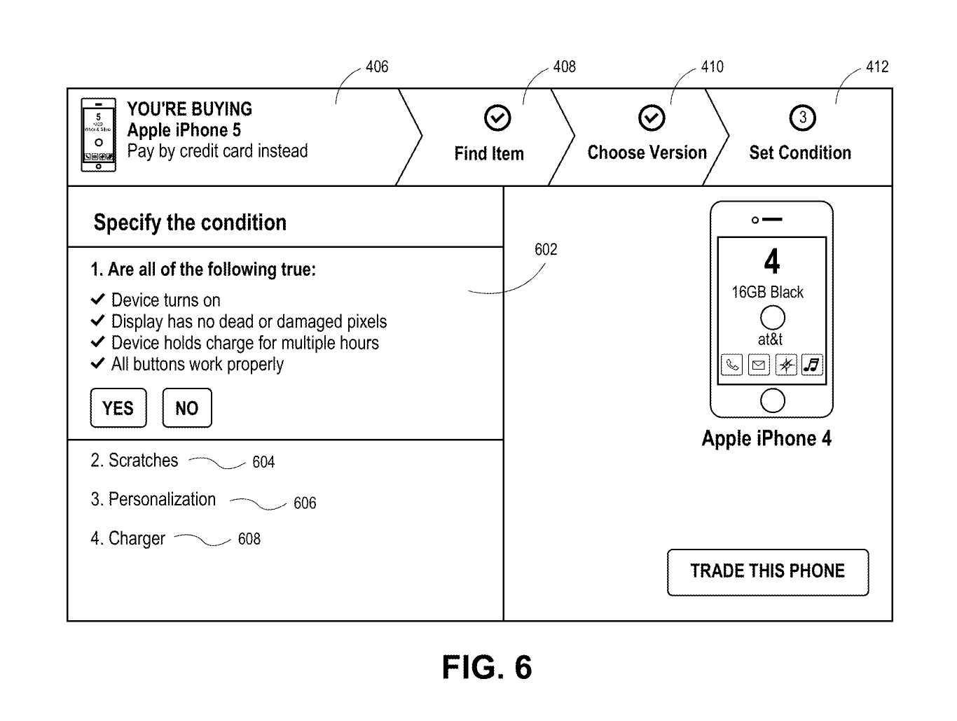

FIG. 6 illustrates an embodiment of the next screen, where the customer performs step 412 to indicate the condition of the used product for trade-in. As shown, first are a set of questions 602 about the operability of the product—does it turn on, does the display have dead or damaged pixels, does the device hold a charge for multiple hours and do all buttons work properly. A next question 604 can bring up a drop-down list of options to describe how scratched the product is, and where the scratches are. Question 606 inquires whether the device was personalized by engraving or otherwise. Question 608 inquires whether a charger for the device or other accessories are included.

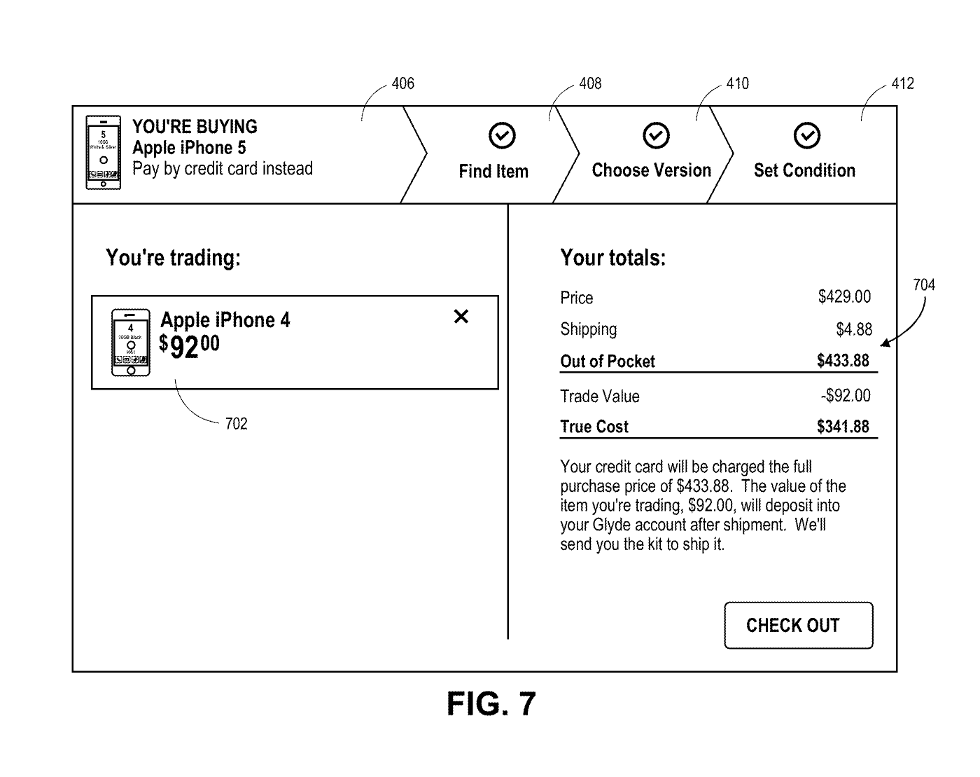

FIG. 7 illustrates one embodiment of a window indicating a trade-in value assigned to the product by the ecommerce site. A box 702 shows a picture of the product and the dollar value the ecommerce site is willing to pay. A column 704 indicates the purchase price, trade-in credit, and true cost of the purchased product, deducting the trade-in value. The trade-in price will take into consideration shipping so it will only display the “in-your-pocket” post trade-in dollar credit the customer will receive.

Many variations of the above described embodiments are possible. While the customer may use the trade-in toward a new product purchase, it can also be used toward a purchase of another used product. Multiple used products can be applied against a single product purchase, or a single used product trade-in could be applied to the purchase of multiple products. If the trade-in value exceeds the purchase price, the customer can get cash back or a credit to apply to future purchases.

The tentative credit can be for a portion of the trade-in value, with the remainder being a current credit or cash payment. The determination of eligibility for an instant credit or cash payment can be based on a customer profile. A customer with a track record and good ratings for providing accurate descriptions and actually shipping the trade-in product can be afforded a greater portion of the trade-in value as a current payment, rather than a tentative credit to be confirmed later (e.g., get $100 now, and then $100 when their trade-in product is shipped).

A customer will usually be shown similar items to prompt a trade in, such as older versions of the same product. However, a customer can also trade-in any unrelated used product for which a used product market buyer exists. The trade-in can also be used against the purchase of services, downloads, or anything else of value.

In one embodiment, the trade-in capability can be pushed to other third party websites, as part of a product purchase widget or otherwise. One embodiment of such a system, to which the trade-in capability described herein can be added, is described in copending application Ser. No. 12/906,013, “Atomizing E-Commerce,” filed Oct. 15, 2010, Pub. No. 20120095881, the disclosure of which is incorporated herein by reference. The buy window shown in such application would also provide the trade-in user interfaces described herein, and link to server 102 as described herein.

In one embodiment, a trade-in price is given only if there is a guaranteed offer (i.e., a standing order). Some buyers are willing to buy in bulk, so they issue a ‘standing order’ to purchase X # of devices at Y price. In another embodiment, a tentative price may be given, or the pricing can be displayed as pending. When the customer trades in a product, it is offered for sale on the used product marketplace. The customer then gets credit once it's sold.

In one embodiment, the customer can be prompted to trade-in a product at other than the buy window or checkout page. The prompting can take the form of ads for products that have willing buyers, and can have an indication of price, or a variety of prices depending on condition, version, etc. The prompting can also be based on products the system knows the customer has bought in the past. The prompting can be tied to particular new or used products being offered for sale on the ecommerce site, or can be independent of such products.

In one embodiment, the purchase market module and the trade-in module are part of a single module. Users can register with an ecommerce site with the option of being a seller and/or a buyer. In addition to searching for items to buy, users can list items to sell and use the system to determine an appropriate list price. One embodiment is described in Glyde U.S. Pat. No. 8,447,645, the disclosure of which is incorporated herein by reference. A trade-in product can be posted on the marketplace website just like any other product offered for sale. The ecommerce marketplace operator can do the posting in the background on behalf of the trade-in requestor. The price it is posted for can be determined using the method set forth in U.S. Pat. No. 8,447,645. The value displayed to the customer will include shipping, a profit margin and a margin to cover variations between the list price and the price actually received.

In one embodiment, the ecommerce site tracks previous buyers of trade-in products. Active buyers of particular products can be sent a message about the availability of new trade-in products for purchase. Such messages can be by email, text message, a posting a notification to a personal webpage of such user on said ecommerce site, etc. The messages can be aggregated, to offer a group of products, even though each individual product is a trade-in from a different customer. In one embodiment, a user can elect to receive such messages, and can specify the types of products of interest.

In one embodiment, each customer or user is prompted to create a profile. The profile includes a shipping address and payment information. The shipping address can be used for calculating a total trade-in value by factoring in shipping costs. The profile can include records that track purchases and sales by the user, for the various reasons described above. In one embodiment, a user can opt-in to having a cookie track purchases on other sites, to develop a more robust history of purchases to be used for trade-in prompts as described above.

### Additional Embodiments

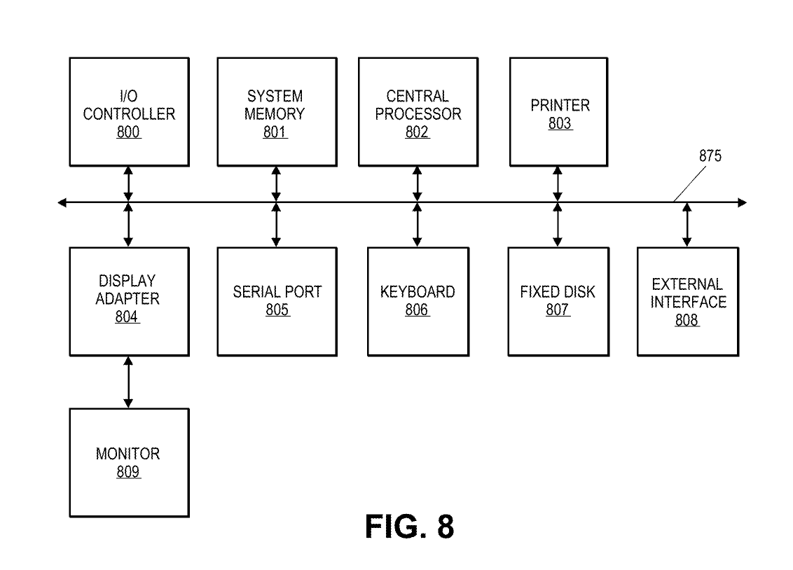

FIG. 8 is a high level block diagram of a computer system that may be used to implement any of the entities or components described above. The subsystems shown in FIG. 8 are interconnected via a system bus 875. Additional subsystems include a printer 803, keyboard 806, fixed disk 807, and monitor 809, which is coupled to display adapter 804. Peripherals and input/output (I/O) devices, which couple to I/O controller 800, can be connected to the computer system by any number of means known in the art, such as a serial port. For example, serial port 805 or external interface 808 can be used to connect the computer apparatus to a wide area network such as the Internet, a mouse input device, or a scanner. The interconnection via system bus 875 allows the central processor 802 to communicate with each subsystem and to control the execution of instructions from system memory 801 or the fixed disk 807, as well as the exchange of information between subsystems. The system memory 801 and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A server computer comprising:
a processor; and
a non-transitory computer readable medium comprising code, executable by said processor, to implement a method comprising:
displaying a buy window for a customer to purchase a product for sale;
displaying, upon activation of said buy window, an option for trade-in of a used product;
in response to an affirmative response by said customer to said option for trade-in, prompting said customer to provide a product description of said used product;
providing said product description to a used product marketplace module;
identifying, by said used product marketplace module, at least one potential third party buyer of said used product;
determining a used product purchase price offered by said third party buyer; and
displaying a used product sell price to said customer, said used product sell price being related to said used product purchase price.

2. The server computer of claim 1 wherein said code further implements a method comprising:
Determining said used product purchase price before or after a transaction with said customer.

3. The server computer of claim 1 wherein said code further implements a method comprising:
providing an option for said user to trade-in multiple used products.

4. The server computer of claim 1 wherein said code further implements a method comprising:
indicating a charge to said customer for a full purchase price for said product for sale;
indicating a conditional credit to said customer for said used product sell price; and
indicating an award of said credit to said customer upon an indication of satisfactory receipt of said used product by said third party buyer.

5. The server computer of claim 1 wherein said code further implements a method comprising:
prompting said customer to indicate a condition of said used product; and
indicating an award of said credit to said customer for said used product sale price upon confirmation by said third party buyer of receipt of said used product matching said condition.

6. The server computer of claim 1 wherein said displaying an option for trade in further comprises:
identifying, using said used product marketplace module, at least one related used product, related to said product for sale, for which there is an identified potential third party buyer; and
displaying to said customer an indication of said related used product as an option for trade-in.

7. The server computer of claim 1 wherein said displaying an option for trade in further comprises:
providing a search prompt;
in response to a user input, searching, using said used product marketplace module, for at least one used product corresponding to said user input, for which there is an identified potential third party buyer; and
displaying to said customer an indication of said related used product as an option for trade-in.

8. The server computer of claim 1 wherein said displaying an option for trade in further comprises:
searching a database for at least one previous product purchased by said customer;
identifying, using said used product marketplace module, at least one identified potential third party buyer of said previous product; and
displaying to said customer a prompt to trade-in said previous product.

9. A server computer comprising:
a processor; and
a non-transitory computer readable medium comprising code, executable by said processor, to implement a method comprising:
displaying a buy window for a customer to purchase a product for sale;
displaying, upon activation of said buy window, an option for trade-in of a used product;
in response to an affirmative response by said customer to said option for trade-in, prompting said customer to provide a product description of said used product;
prompting said customer to indicate a condition of said used product;
providing said product description to a used product marketplace module;
identifying, by said used product marketplace module, at least one potential third party buyer of said used product;
determining a used product sell price offered by said third party buyer;
displaying said used product sell price to said customer:
indicating a charge to said customer for a full purchase price for said product for sale;
indicating a conditional credit to said customer for said used product sell price; and
indicating an award of said credit to said customer for said used product sale price upon confirmation by said third party buyer of receipt of said used product matching said condition.

10. The server computer of claim 9 wherein said displaying an option for trade in further comprises:
identifying, using said used product marketplace module, at least one related used product, related to said product for sale, for which there is an identified potential third party buyer; and
displaying to said customer an indication of said related used product as an option for trade-in.

11. A computer-implemented method comprising:
displaying a buy window for a customer to purchase a product for sale;
displaying, upon activation of said buy window, an option for trade-in of a used product;
in response to an affirmative response by said customer to said option for trade-in, prompting said customer to provide a product description of said used product;
providing said product description to a used product marketplace module;
identifying, by said used product marketplace module, at least one potential third party buyer of said used product;
determining a used product sell price offered by said third party buyer; and
displaying said used product sell price to said customer.

12. The method of claim 11 further comprising:
providing an option for said user to trade-in multiple used products.

13. The method of claim 11 further comprising:
indicating a charge to said customer for a full purchase price for said product for sale;
indicating a conditional credit to said customer for said used product sell price; and
indicating an award of said credit to said customer upon an indication of satisfactory receipt of said used product by said third party buyer.

14. The method of claim 11 further comprising:
prompting said customer to indicate a condition of said used product; and
indicating an award of said credit to said customer for said used product sale price upon confirmation by said third party buyer of receipt of said used product matching said condition.

15. The method of claim 11 wherein said displaying an option for trade in further comprises:
identifying, using said used product marketplace module, at least one related used product, related to said product for sale, for which there is an identified potential third party buyer; and
displaying to said customer an indication of said related used product as an option for trade-in.

16. The method of claim 11 wherein said displaying an option for trade in further comprises:
providing a search prompt;
in response to a user input, searching, using said used product marketplace module, for at least one used product corresponding to said user input, for which there is an identified potential third party buyer; and
displaying to said customer an indication of said related used product as an option for trade-in.

17. The method of claim 11 wherein said displaying an option for trade in further comprises:
searching a database for at least one previous product purchased by said customer;
identifying, using said used product marketplace module, at least one identified potential third party buyer of said previous product; and
displaying to said customer a prompt to trade-in said previous product.
